(19) United States
(12) Patent Application Publication
(10) Pub. No.: US 2026/0022471 A1
(43) Pub. Date: Jan. 22, 2026

(54) WATER ELECTROLYSIS SYSTEM AND METHOD

(71) Applicants: Lourdes Vernet, SHREWSBURY, PA (US); Martin Ruben Vernet Vacchiani, CORDOBA (AR)

(72) Inventors: Martin Ruben Vernet Vacchiani, Cordoba (AR); Jorge Adrian Capello, Cordoba (AR)

(73) Assignees: Martin Ruben Vernet Vacchiani, CORDOBA (AR); Lourdes Vernet, SHREWSBURY, PA (US)

(21) Appl. No.: 18/995,749

(22) PCT Filed: Jul. 21, 2022
(86) PCT No.: PCT/US2022/073982

§ 371 Date: Jan. 16, 2025

(51) Int. Cl. C25B 1/04; C25B 1/50; C25B 9/70

(52) U.S. Cl. CPC C25B 1/04; C25B 1/50; C25B 9/70

(57) ABSTRACT

A water electrolysis system including a container; a plurality of microcells located inside the container; the microcells are centered around a central axis of the container; a first bracket located on a first side of the microcells; a second bracket located on a second side of the microcells; a plurality of magnets mounted on the first and the second brackets, the magnets are placed in parallel to the microcells; a liquid inside the container. The first and the second brackets are adapted to be connected to a motor. The first and the second brackets rotate during the electrolysis process. The magnets on the first bracket produce a first magnetic field and the magnets on the second bracket produce a second magnetic field; and the first and the second magnetic fields have opposite polarity.

### FIELD OF THE INVENTION

The application relates to a method for producing hydrogen, and more particularly, to a method for producing hydrogen by using water electrolysis.

### BACKGROUND OF THE INVENTION

Electrolysis is a process that separates elements of a compound using electricity. Electrolysis of water was discovered over one hundred years ago and consists of breaking apart the water molecule (H₂O) into oxygen (O₂) and hydrogen (H₂) gases through a continuous electric current delivered by a power source that is connected through water electrodes. The electrons are liberated by anions in the anode and electrons are captured by cations in the cathode.

Water is composed of an oxygen atom and two hydrogen atoms. Each hydrogen atom is covalently bonded to the oxygen atom by a pair of bonded electrons. The oxygen also has two pairs of non-bonded electrons. As such, there are four pairs of electrons surrounding the oxygen atom: two pairs forming part of the covalent bonds with the hydrogen atoms and two pairs that are not shared on the opposite side. Unlike hydrogen, oxygen is an electronegative, or “electrophilic,” atom.

In addition, water is a “polar” molecule; that is, it has an irregular distribution of electron density. For this reason, water has a partial negative charge near the oxygen atom and a partial positive charge near the hydrogen atoms.

These atoms are bonded to one another by forces that are called chemical bonds. These bonds have a certain energy associated with them, with a certain value (called “bond energy”). If a water molecule is combined with an electrolyte and applied to it, in a continuous current, by a quantity of electric energy that is greater than that of the bonds that link its atoms, they will break, and by so doing, will divide the molecule into oxygen and hydrogen.

Specifically, the process is carried out through a source of electric energy connected to two electrodes made of platinum or stainless steel, which represent the positive and negative poles. These electrodes are placed in contact with the water. The water's contact with the applied current produces the molecular breakdown.

During the electrolysis process, the cathode in the water is negatively charged, a reduction of the reaction occurs, with the electrons (e−) from the cathode being given to the hydrogen cations to form hydrogen gas.

Cathode half-reaction:

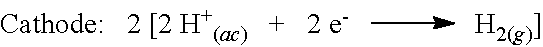

In the positively charged anode, an oxidation produces the reaction, producing the generation of oxygen gases and giving electrodes to the anode to complete the circuit:

Anode half-reaction:

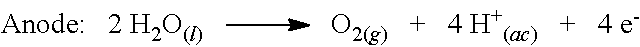

Which is why if we balance both half-reactions:

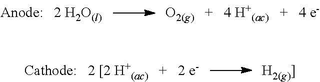

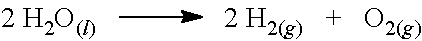

The gases obtained through this electrolysis of water process have different applications. Hydrogen (H) is a fuel whose application in the energy industry has enormous potential. The main benefit of hydrogen as a fuel is that it does not produce greenhouse gases, as other known (and more widely used) gases do, such as petroleum or natural gas.

Unfortunately, despite being one of the most abundant elements on Earth, hydrogen is not easy to obtain, as it is not found in isolation in nature.

Hydrogen is usually obtained directly from water through electrolysis.

There are two main technologies available on the market, alkaline and polymer electrolyte membrane (PEM) electrolyzers. Alkaline electrolyzers are cheaper in terms of investment (they generally use nickel catalysts), but they are less efficient. PEM electrolyzers, on the other hand, are much more expensive (they generally use platinum-group metal catalysts) but they are more efficient and can operate at densities with higher currents and, as such, can potentially be cheaper if hydrogen production is large enough.

Unfortunately, the current techniques are not efficient. The energetic cost to produce hydrogen, by the known methods, is high, compared with the quantity of hydrogen obtained.

There is a need to produce hydrogen in a more cost-efficient way.

### SUMMARY OF THE INVENTION

A water electrolysis system including a container; a plurality of microcells located inside the container; the microcells are centered around a central axis of the container; a first bracket located on a first side of the microcells; a second bracket located on a second side of the microcells; a plurality of magnets mounted on the first and the second brackets, the magnets are placed in parallel to the microcells; a liquid inside the container. The first and the second brackets are adapted to be connected to a motor. The first and the second brackets rotate during the electrolysis process. The magnets on the first bracket produce a first magnetic field and the magnets on the second bracket produce a second magnetic field; and the first and the second magnetic fields have opposite polarity.

### BRIEF DESCRIPTION OF THE DRAWINGS

FIG. 1 shows the tension thereby generated by the electromotive forces according to the Faraday principle;

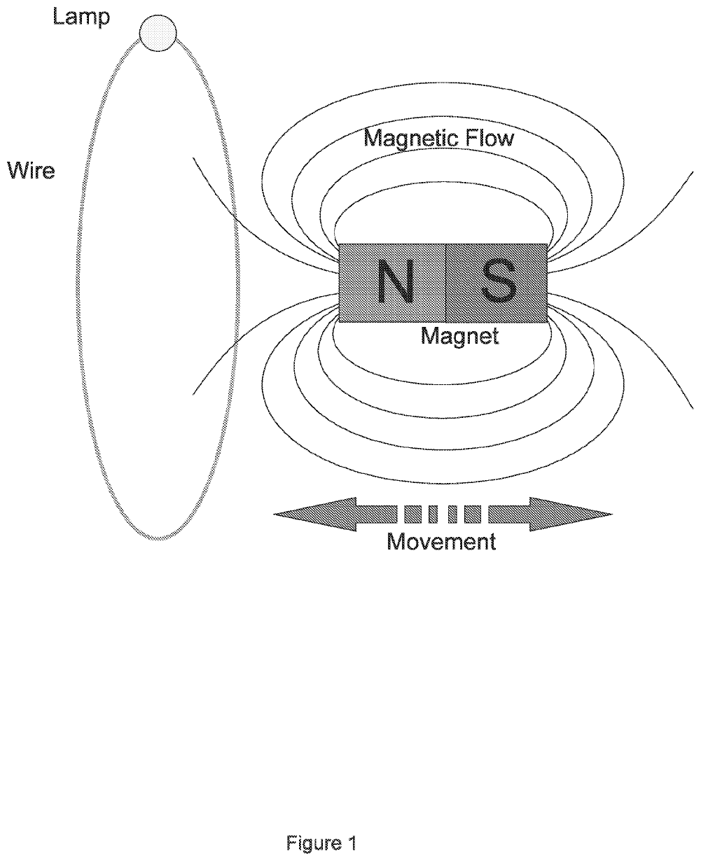

FIG. 2 shows the current moving between the plates of electrolytic cells;

FIG. 3 shows the current moving between the plates of an electrolytic cell when a magnetic field is applied;

FIG. 4 shows the current moving between the plates of an electrolytic cell according to the present invention when a rotation is applied to the magnetic field of FIG. 32;

FIG. 5 shows the system according to the present invention showing a 36 volt electrolysis cell;

FIG. 6 shows the system according to the present invention showing a 12 volt electrolysis cell;

FIG. 7a shows the results of the experiments performed on the 36 volt cell; and

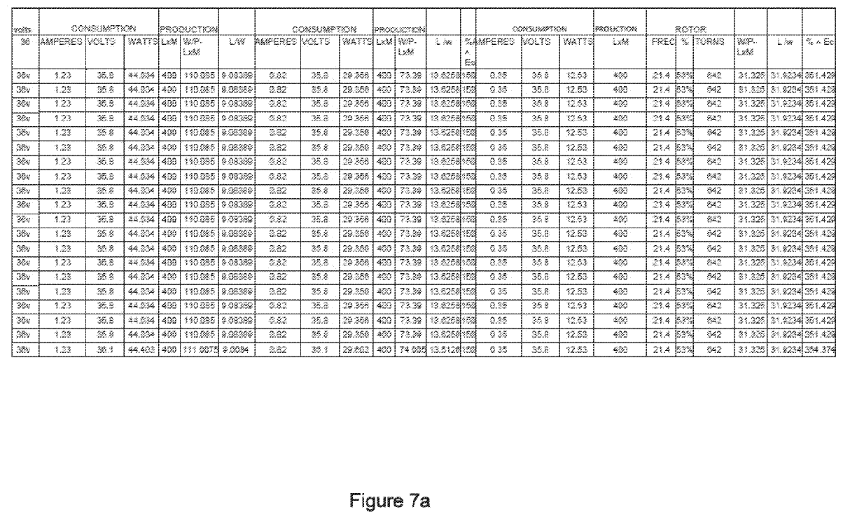

FIG. 7b shows the results of the experiments performed on the 12 volt cell.

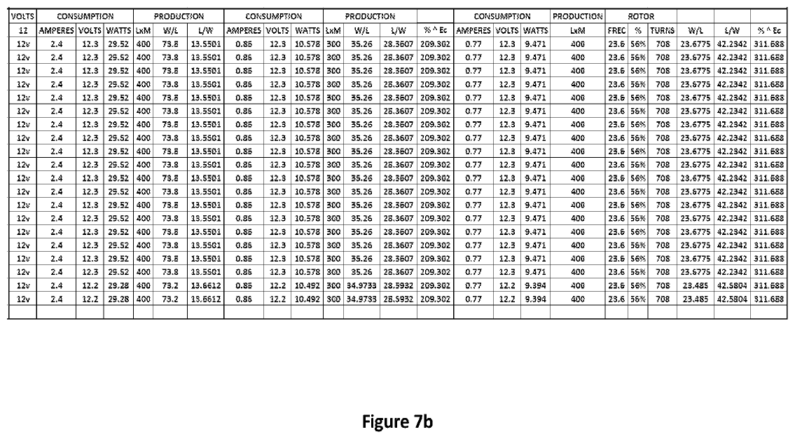

### DETAILED DESCRIPTION OF THE INVENTION

A water electrolysis system including a container; a plurality of microcells located inside the container; the microcells are centered around a central axis of the container; a first bracket located on a first side of the microcells; a second bracket located on a second side of the microcells; a plurality of magnets mounted on the first and the second brackets, the magnets are placed in parallel to the microcells;

a liquid inside the container. The first and the second brackets are adapted to be connected to a motor. The first and the second brackets rotate during the electrolysis process. The magnets on the first bracket produce a first magnetic field and the magnets on the second bracket produce a second magnetic field; and the first and the second magnetic fields have opposite polarity.

The method according to the present invention includes the steps of:
performing a water electrolysis process; and
applying a magnetic field during the water electrolysis process, the magnetic field is generated by magnets or electromagnets.

The magnetic field should be kept at the minimum possible distance from the electrolysis process and the distance will depend on the size of the cell.

Adding the magnetic field to the electrolysis process generates more efficiency in the electrolysis process through the induction of current obtained by the influence of the magnetic fields generated in the electrolysis process.

The desired effect is increasing the intensity of the current applied to the electrolysis, without increasing consumption, and thereby obtaining a greater efficiency in the process.

The solution proposed is based on the influence of a magnetic field on the water electrolysis process. To understand the desired effect, it can be observed that if a magnetic field is placed in water, making instances of electrodes (cathode or anode), the gas obtained when applying the electric current has a circular movement pattern.

In an electrolysis process, current flows that go from one electrode to the other are generated. All current flows generate a magnetic field. This magnetic field is in movement since it is generated by the current flow that is generated when passing from one electrode to the other.

What the method accomplishes is to induce and affect those small magnetic fields with another larger one, increasing their intensity. By increasing the intensity of those small magnetic fields, a current is consequently generated. These fields are a closed circuit of current where resistance tends toward zero. This increase of intensity transforms proportionally to an increase in current, which is applied directly to the electrolysis process, thereby achieving better efficiency results. This induced magnetic field in a state of circular movement around the fields generated by the current flows from the electrolysis itself will increase the effect, thereby achieving greater efficiency in the electrolysis process.

To make the present method understandable, a preferred performance mode will be described in which it is put into practice. All this serves as, but is not limited to, being merely a demonstrative example, whose components may be selected among various equivalents, without thereby diverging from the principles established in this documentation.

The components of the preferred performance mode are:

The preferred example includes three 36-v electrolytic microcells (there could also be four 12-v electrolytic cells) within a water container. At its sides, held by two vertical brackets, there are eight magnets (four on each side), which have opposing polarities. The vertical brackets are joined at the bottom to an external axis connected to a turntable.

To properly perform the process of electrolysis of water, an electrolyte is added. The electrolyte improves the conduction of the current through the water. The water's electrolyte has to be present between approximately 1.5% to 3%. The electrolyte to be used will depend on the purity of the water and the distance between electrodes.

When applying the current (from an exterior energy source) to the microcells, the current enters through the anode and moves through the water combined with an electrolyte, passing through the neutral plates until it is received by the cathode. In this process, the input current breaks the water molecules through the process described initially as electrolysis of water.

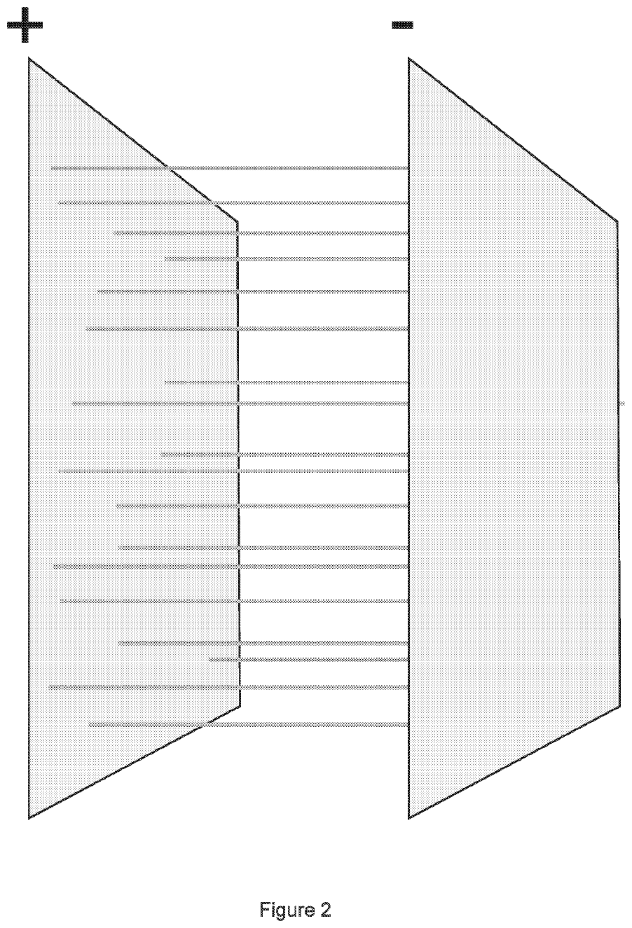

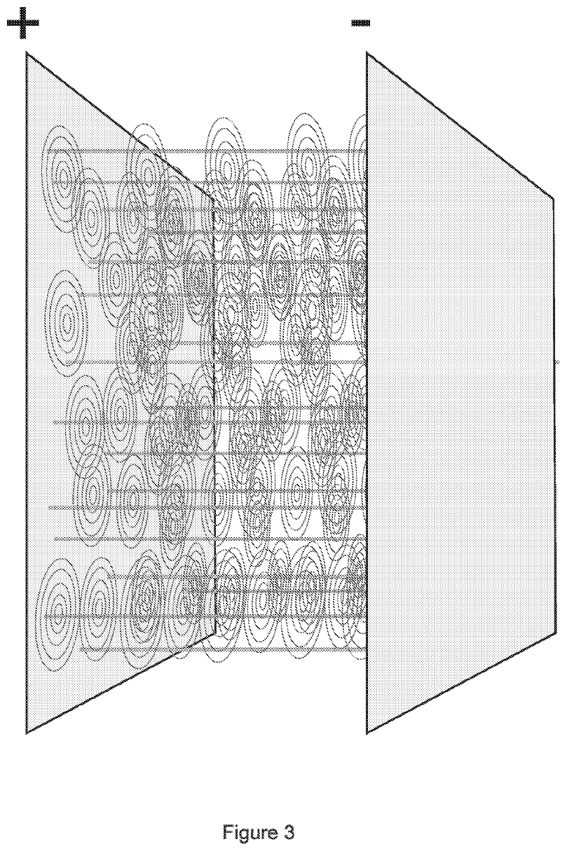

This current flow that moves through the water, combined with an electrolyte, generates magnetic fields. FIG. 2 plots the current that moves between the plates. FIG. 3 plots the magnetic fields generated by said current and which moves together with it.

The magnetic field generated by the magnets added to the system—which are arranged with opposing polarities and rotating around the microcells via the central axis and brackets—applied during the electrolysis process, that is, while the current is moving through the water combined with an electrolyte and breaking the hydrogen molecules, influences and affects the small magnetic fields generated by the current, plotted in FIG. 3.

This influence, according to Michael Faraday's Law of Induction, Foucault's Currents and Lenz's Law, generates an increase in the intensity of the small magnetic fields generated by the current, which translates to an increase in the intensity of the current.

The increase in the intensity of the current within the microcell has as an effect that, in the context of electrolysis, more H₂O molecules present within the system decompose. As such, a greater quantity of hydrogen (H₂) is obtained without increasing the consumption coming from the source.

To demonstrate this efficiency, it is defining the production capacity in a consumption unit, between what is obtained once the method is applied, called “Es”, and the production capacity in a consumption unit before inducing the method, working conventionally, called “Ei”. Using symbols and using “ef %” for efficiency:

$$ef \% = Es / Ei {.}^{*} 100$$

The efficiency achieved with the application of this method varies according to the state of the magnetic field generated. In the Performance Example section, the results obtained from this preferred example of performance on 36-v and 12-v cells can be assessed.

Before explaining this method, the Michael Faraday's Law of Induction must be explained, on Foucault's Currents, and on Lenz's Law.

It is known that an electric current can be created using a magnetic field; this current will be called “induced current.”

The discovery of electromagnetic induction is attributed to Michael Faraday based on Oersted's discovery that a magnetic field is created around a wire through which an electric current flows; thus, the wire has magnetic properties. Faraday discovered the converse, that when a variable magnetic field moves or varies crossing a conductor, it generates a difference of potential (tension) at the ends of the conductor, and that it if it's closed with a circuit, for example by connecting the wire to a lamp, the current flows through this circuit; that is, the circuit must be closed or the wire's ends must be joined, with or without resistance. In essence, he discovered how to generate electricity or electric current using a magnetic field and movement. (Induced Current).

Tension thereby generated is called electromotive force (hereinafter EMF).

Faraday also proved that the faster the conductor crossed the lines of the magnet's magnetic field, the greater the induced electric current produced in the circuit.

The lines of the magnetic field are called Magnetic Flow, thus the greater the magnetic flow crossed by the conductor, the greater the induced tension will be. On the other hand, an electric phenomenon was discovered by the French physicist Léon Foucault in 1851. It occurs when a conductor passes through a variable magnetic field, or vice versa. The relative movement causes a flow of electrons, or an induced current within the conductor. Foucault's circular currents create electromagnets with magnetic fields that oppose the effect of the applied magnetic field (Lenz's Law). The stronger the magnetic field applied, or the greater the conductor's conductivity, or the greater the speed relative to the movement, the greater Foucault's currents and the generated opposing fields will be.

Thus, it can be said that the EMF is equal to the variation of the magnetic flow in relation to time multiplied by the quantity of coils the conductor has.

$$FEM = - N \frac{{}_{d} ϕ B}{{}_{d} t}$$

In the present invention, the conductor of the current is a solid metallic plate and not a coil, but a solid metallic plate can be seen as thousands of concentric coils inside one another occupying the whole area of the material, and as such, these laws apply in the same way.

As mentioned previously, two polarized metallic plates (one positive [1] and the other negative [2]) are joined by a conductor (water+an electrolyte) through which a current flows. This conductor could be represented as thousands of imaginary wires that join both plates and through which the current flows (FIG. 2).

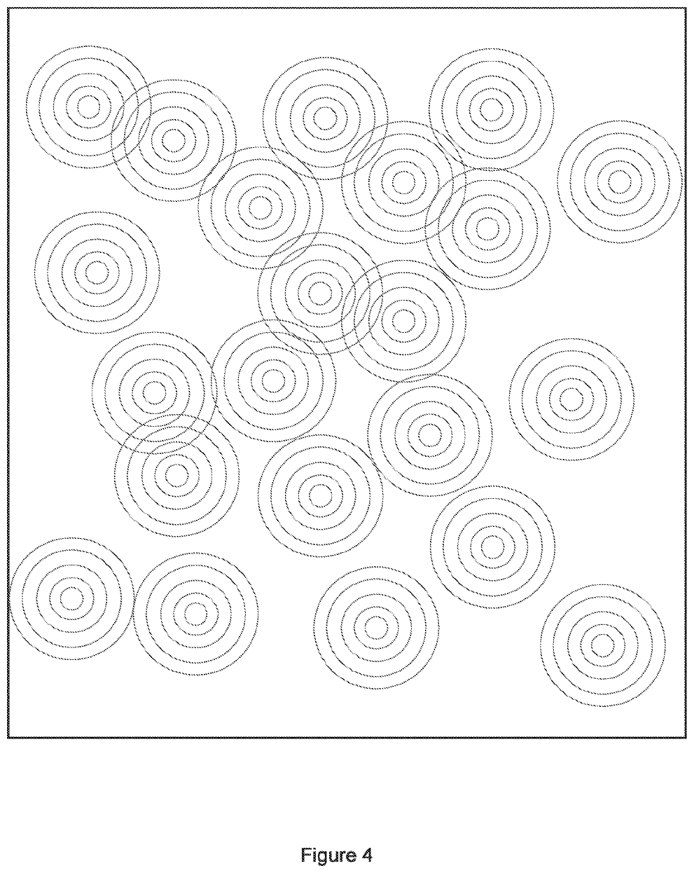

When a current flows through these imaginary wires, circular magnetic fields are generated which surround the path of the current, which are also formed in the metallic plates (FIGS. 3 and 4). On the other hand, permanent magnetic fields produced by magnets which pass through, at different angles, the variable fields that are generated by the path of the current. The magnetic flow is equal to the magnetic field by the surface area that it passes through and multiplied by the cosine of the angle of incidence.

Thus, we know that this variation of the angle of incidence produces eddy currents that are induced in these variable fields. Furthermore, magnets with permanent magnetic fields rotate around the system, making the angle of incidence between the fields vary rapidly with respect to time. This variation is directly proportional to the speed of the magnets' rotation, thereby drastically increasing the quantity of eddy currents in the variable fields and now also in the metallic plates that are affected by the angle change of the magnet's permanent magnetic field, as well as by the changing proximity and distance of the rotating magnets. All of this makes it so that the metallic plates' eddy currents are also induced in the variable magnetic fields, further increasing the induced current.

As we mentioned previously, a metallic plate can be taken as thousands of concentric coils; each one of these coils is closed and thus they are a short circuit or, equivalently, and its resistance is very low.

By the Ohm's law, the current is directly related to resistance and voltage, in this case without the eddy currents' EMF magnitude mattering too much. The fact that the resistance is so small, increases the current, thus Foucault's currents tend to be high which favors induction.

### Performance Example

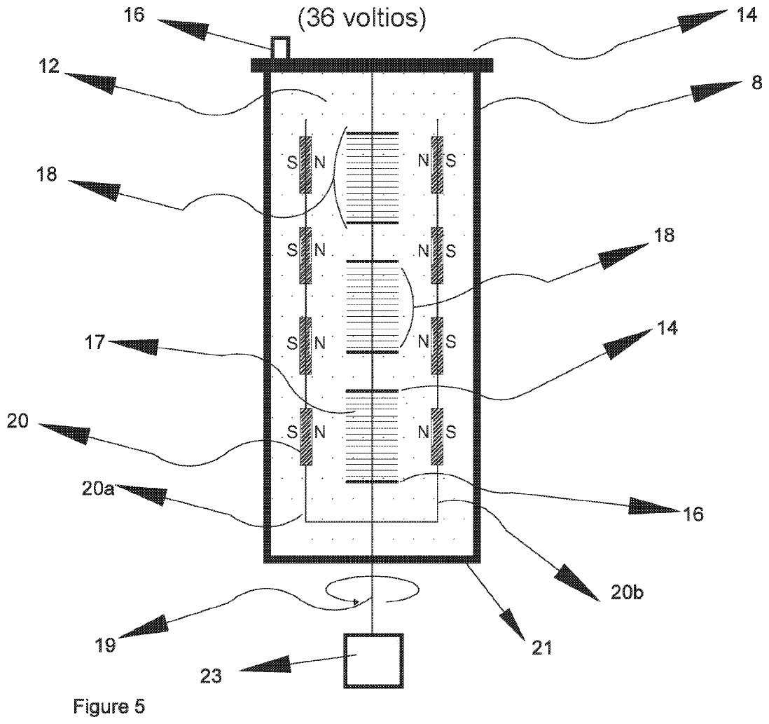

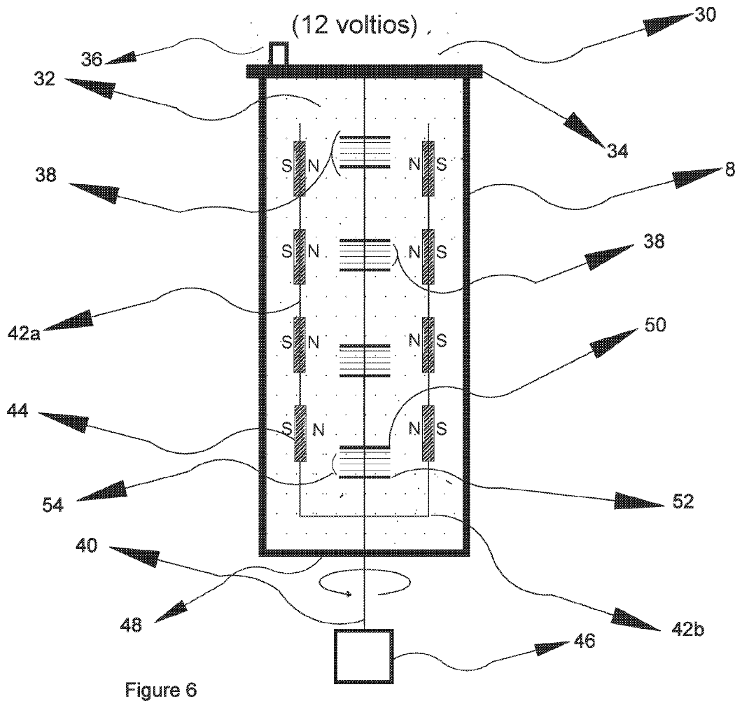

Trials with conventional wet cells were performed. The trials were performed in a cell built to operate with 36 v (FIG. 5) and, later, with another to operate with 12-v (FIG. 6) input directly from the source.

### 36-Volt Cell

The cell that works at 36 volts is built in a tubular acrylic container receptacle 12 that is 33 centimeters long and with an interior diameter of 94 mm.

The upper cap 14 has the outlet 16 for the resultant gas.

The interior has three microcells 18 that are centered around a central axis 19 that also supports the two magnetic field brackets 20a, 20b (generated in this case by magnets), attached to an external electric motor 23 by way of the lower cap 21. The receptacle 12 is full of water+electrolyte.

The three microcells 18 are 36 v. Each one of the microcells 18 contains one anode 14, one cathode 16, and neutral plates 17 placed between them, and the distance between the electrodes is between 1 to 8 millimeters, preferably about 2 millimeters. The electrodes are circular with a diameter between 30 to 45 millimeters, preferably of 43 millimeters.

These microcells 18 are located between two magnetic field brackets 20a, 20b, each magnetic field bracket 20a, 20b contains four magnets 20, each magnet 20 generates a magnetic field by one grade-n 38 neodymium magnet. Each magnet 20 has a diameter between 15 to30 millimeters, preferably 25-millimeter and a thickness between 2 to 4 millimeters, preferably 3 mm. The magnets 20 are placed in parallel to the microcells 18, with a distance between them of 30 to 50 millimeters, preferably of 45 millimeters. The magnetic fields generated by the magnets 20 have opposing polarity.

The magnetic field brackets 20a, 20b rotate in the same direction while the electrolysis process takes place, using an external axis attached to the electric motor 23.

The water's electrolyte has to be present between approximately 1.5% to 3% in 2 liters.

The electrolyte to be used will depend on the purity of the water and the distance between electrodes. In this specific case, the electrolyte was added to the water until enough resistance was generated for the cell to be able to consume about 1.2 amperes generating 0.4 liters per minute of resultant gas. Resulting in approximately 1.5% of electrolyte in water. Mains water was used since one of the objectives of the present invention is to obtain results in water that hasn't been distilled.

### Trials Performed at 36 Volts

Twenty trials were performed in which the consumption and production ratio was registered in three consecutive stages per trial.

Consumption and production were registered at each stage, once they were stabilized and maintained for three minutes (ruling out the possibility that performance losses or gains exceed one minute, according to registers of tests done regarding efficiency variations for 30 minutes once production was stabilized. These were done beforehand, wherein, once production and consumption were stabilized, variation was not registered in any of the 20 tests done).

### The Registers Were Taken in Three Stages

The first stage was taken as an index, where the cell operated in conventional conditions, without applying a magnetic field.

The second stage follows the first, and in this stage the previously explained magnetic field is applied statically. In this case, when noting a reduction in the cell's production in the second stage, caused by the lack of electrolyte when intensifying the induced current. We added the electrolyte necessary to stabilize production again at 0.4 liters/minute, and registered values below those conditions in the same production.

And the third and final stage following the previous stage. Rotation was applied to the magnetic field added in stage 2. The turns of this rotation were applied increasingly until achieving optimal efficiency for the cell being utilized. Electric consumption of the motor that creates the rotation is not taken into account, as only the consumption produced to generate electrolysis is considered.

### Results

First stage: Cell operating without magnetic fields placed within the cell. The cell, once its production was stabilized, demonstrated results of a consumption of 1.2 amperes at 35.8 volts (consumption in watts of 42.96) for a production of 0.4 liters per minute.

A ratio of 110 watts per liter/minute.

In the second stage: magnetic fields were placed inside the cell in static condition.

Once stabilized, the cell demonstrated consumption results of 0.82 amperes with 35.7 volts (consumption in watts of 29.35) for a production of 0.4 liters per minute.

A ratio of 73.39 watts per liter/minute.

Achieving an efficiency of 146.34%.

Third stage: the rotation is applied to the bracket holding the magnetic fields. Rotating condition. The best performance was achieved at a rotation regimen of 648 turns per minute.

Once the cell was stabilized, it demonstrated consumption results of 0.35 amperes with 35.8 volts (consumption in watts of 12.53), for a production of 0.4 liters per minute.

A ratio of 31.32 watts per liter/minute.

Achieving an efficiency of 351.42%

### 12-Volt Cell (FIG. 6)

The cell 30 working at 12 volts is built in a tubular acrylic container receptacle 32 that is between 33 to 40 centimeters long, preferably 33 centimeters long and with an interior diameter between 92 to100 mm, preferably of 94 mm.

The upper cap 34 has the outlet 36 for the resultant gas.

The interior has four microcells 38 that are centered around a central axis 40 that also supports the two magnetic field brackets 42a, 42b, generated in this case by magnets 44, attached to an external electric motor 46 by way of the lower cap 48. The container is full of water+electrolyte.

The four microcells 38 are 12 v. Each one contains one anode 50, one cathode 52, and four neutral plates 54 placed between them. The distance between the electrodes 38 is between 1 to 8 millimeters, preferably 2 millimeters. The electrodes 38 are circular with a diameter between 30 to 45 millimeters, preferably 43 millimeters.

The microcells 38 are located between two magnetic field brackets 42a, 42b, each magnetic field bracket 42a-b contains four magnets 44. Each magnet 44 generates a magnetic field by one grade-n 38 neodymium magnet, with a diameter of between 15 to 30 millimeters, preferably 25-millimeter and a thickness between 2 to 4 mm, preferably 3 mm and they are placed parallel to the microcells, with a distance between them of between 30 to 50 millimeters, preferably 45 millimeters. The magnetic fields generated by the magnets have opposing polarity.

The magnetic fields brackets 42a, 42b has the capacity to rotate while the electrolysis process takes place, using an external axis attached to an electric motor 46. The magnetic fields brackets 42a, 42b rotate in the same direction.

The water's electrolyte has to be present between approximately 1.5% to 3%. The electrolyte to be used will depend on the purity of the water and the distance between electrodes 38. In this specific case, the electrolyte was added to the water until enough resistance was generated for the cell to be able to consume 2.4 amperes generating 0.4 liters per minute of resultant gas. Resulting in approximately 1.5% of electrolyte in water. Mains water was used (since the goal of the trials is to obtain results in water that hasn't been distilled).

### Trials Performed at 12 Volts

Twenty trials were performed in which the consumption and production ratios were registered in three consecutive stages per trial.

Consumption and production were registered at each stage once they were stabilized and maintained for three minutes according to the same concept performed in the previous test.

### The Registers Were Taken in Three Stages

The first stage was taken as an index, where the cell operated in conventional conditions, without applying a magnetic field.

The second stage follows the first, and in this stage the previously explained magnetic field is applied statically. When increasing the induced current, we can also see the reduction of resultant production, but in this case, no necessary electrolyte is added to equal the production of the first stage. Direct registers were instead taken, thus also being able to compare the ratios between consumption watts and production in different productions, and the efficiency achieved in the stage.

And the third and final stage following the previous stage. Rotation was applied to the magnetic field added in stage 2. The turns of this rotation were applied increasingly until achieving optimal efficiency for the cell being utilized. Electric consumption of the motor that creates the rotation is not taken into account, as only the consumption produced to generate electrolysis is considered.

### Results

First stage: Cell operating without magnetic fields, conventionally.

The cell, once its production was stabilized, demonstrated results of a consumption of 2.4 amperes at 12.3 volts, consumption in watts of 29.52. For a production of 0.4 liters per minute.

A ratio of 73.8 watts per liter/minute.

In the second stage; magnetic fields are placed inside the cell in static condition.

The cell, once stabilized, demonstrated results of a consumption of 0.86 amperes with 12.3 volts, a consumption in watts of 10.57. For a production of 0.3 liters per minute.

A ratio of 35.26 watts per liter/minute.

Achieving an efficiency of 209.3%.

Third stage: the rotation is applied to the bracket holding the magnetic fields.

Rotating condition. The best performance was achieved at a rotation regimen of 708 turns per minute.

The cell, once stabilized, demonstrated results of a consumption of 0.77 amperes with 12.3 volts, a consumption in watts of 9.47. For a production of 0.4 liters per minute.

A ratio of 23.67 watts per liter/minute.

Achieving an efficiency of 311.68%.

### Conclusion Regarding Results Obtained

In the first stage of both trials, we can see logical results for a conventional cell suitable for 36 volts and 12 volts, tailored to the concept of microcells for the size used. Demonstrating for the 36-v one, average results of 110 watts per liter/minute of resultant gas production net from electrolysis. While in the 12-v one, an average result of 73.8 watts per liter/minute of resultant gas production net from electrolysis.

In the second stage, when applying the magnetic field generated by both columns with opposing pole magnets. In the cell we can see a notable reduction of amperage consumed, in relation to production, without modifications in voltage.

Achieving consumptions of 36 watts per liter/minute for the 36-volt cell, a 145% efficiency achieved, and consumptions of 35.26 watts per liter/minute for the 12-v cell, a 209.3% efficiency.

In the third stage, when applying rotation to the magnetic fields, further increasing the induced current. We can see the maximum efficiency achieved at a turn regimen indicated for each cell.

Obtaining consumptions of 31.32 watts per liter in the 36-v cell, 351.4% efficiency achieved.

While in the 12-v one, consumptions of 23.67 watts per liter/minute were obtained, achieving a 311.68% efficiency.

We can also see that in the 12-v cell, with the reduction of production in the second stage, to which no electrolyte was added to get to the base production of the first stage. The production with the effect achieved by the rotating magnetic field was recovered to the base production stabilized in the first stage, 0.3 liters/minute to 0.4 liters/minute was recovered, but with over 300% efficiency with regard to consumption.

1. A water electrolysis system comprising:
a container;
a plurality of microcells located inside the container; the microcells are centered around a central axis of the container;
a first bracket located on a first side of the microcells;
a second bracket located on a second side of the microcells;
a plurality of magnets mounted on the first and the second brackets, the magnets are placed in parallel to the microcells;
a liquid inside the container;
wherein the first and the second brackets are adapted to be connected to a motor,
wherein the first and the second brackets rotate during the electrolysis process;
wherein the magnets on the first bracket produce a first magnetic field and the magnets on the second bracket produce a second magnetic field; and
the first and the second magnetic fields have opposite polarity.

2. The water electrolysis system according to claim 1, wherein the microcells are 12V cells.

3. The water electrolysis system according to claim 1, wherein the microcells are 36V cells.

4. The water electrolysis system according to claim 1, wherein the microcells are spaced apart at a distance of 45 millimeters.

5. A method for producing hydrogen comprising the steps of:
obtaining the water electrolysis system according to claim 1;
performing a water electrolysis process;
applying a magnetic field to the water electrolysis process at the same time that the first and the second brackets are rotated.
